(19) United States
(12) Patent Application Publication
(10) Pub. No.: US 2002/0153023 A1
(43) Pub. Date: Oct. 24, 2002

(54) Method for cleaning out silicon-rich oxide in a pre-clean chamber

(76) Inventors: Chia-ming Kuo, Hsin-chu (TW); Chao-yuan Huang, Hsin-chu (TW)

Correspondence Address: BIRCH STEWART KOLASCH & BIRCH, PO BOX 747, FALLS CHURCH, VA, 22040-0747, US

(21) Appl. No.: 09/837,169

(22) Filed: Apr. 19, 2001

(51) Int. Cl. B08B 6/00

(52) U.S. Cl. 134/1.1; 438/905

(57) ABSTRACT

A method for cleaning out silicon-rich oxide in a pre-clean chamber includes a fluoride induction step, a plasma formation step and a draw-out step. In this method, a fluoride is employed to produce plasma. The plasma of the fluoride reacts with silicon-rich oxide formed on a bell-jar to produce volatile reactants and then the reactants are drown out. With this method, the silicon-rich oxide on the bell-jar is efficiently and quickly cleaned out.

### BACKGROUND OF THE INVENTION

A. Field of the Invention

The invention relates to a method for cleaning out silicon-rich oxide in a pre-clean chamber and, more particularly, to a method for cleaning out silicon-rich oxide in a pre-clean chamber of a physical vapor deposition (PVD) device.

B. Description of the Related Art

In a conventional semi-conductor manufacturing procedure, a PVD device is used to execute a metallic film plating procedure. As shown in FIG. 1, a conventional PVD device includes a buffer chamber 1, a pre-clean chamber 2, a transfer chamber 3, a process chamber 4 and a robot arm 5. The pre-clean chamber 2 is employed to execute a wafer pre-cleaning procedure. As shown in FIG. 2, the pre-clean chamber 2 includes a radio frequency (RF) generator 21, a bell-jar 22, a shield 23, and a pre-clean chamber body 24. When the pre-cleaning of a wafer 6 is going to be executed, the wafer 6 is transferred into the pre-clean chamber 2 by the robot arm 5. Then, a gas such as argon is induced into the pre-clean chamber 2 which is then ionized into plasma through the RF wave from the RF generator 21. By impacting the plasma onto the wafer 6, etching removes chemical residue remaining on the wafer 6 surface. It also removes the thin layer of oxide which is formed when the wafer 6 is exposed to atmosphere.

When the pre-cleaning of the wafer 6 is completed by plasma etching method, The removed material further adhere to the bell-jar 22 and the shield 23. In this case, if the metallic film deposition procedure to be executed in the PVD device is an pre-metallic deposition procedure like Cobalt deposition process, the essential surface ingredient of the wafer 6 to be pre-cleaned in the pre-clean chamber 2 is silicon as usual. Therefore, after multiple pre-cleaning procedures, a large amount of silicon-rich oxide will accumulate on the bell-jar 22 and the shield 23. Since the bell-jar 22 is generally made of quartz and the adherent effect between the silicon-rich oxide and the quartz is poor, a peeling phenomenon occurs leading to particle contamination on the wafer 6 in the pre-clean chamber 6. Therefore, any subsequent metallic film manufacturing procedure will be inversely affected.

To resolve the above-mentioned problem, a manufacturer, usually, will clean the bell-jar 22 after a certain period of time to avoid the particle problem caused by the peeling of silicon-rich oxide from the bell-jar 22. However, the manufacturing procedure must be suspended during the cleaning period and thus the production efficiency is inversely affected. Therefore, it is an important objective to provide a simple method for cleaning out the silicon-rich oxide on bell-jar 22 efficiently and quickly so as to reduce the maintenance time and promote production efficiency.

### SUMMARY OF THE INVENTION

In view of the above, an objective of the invention is to provide a method for cleaning out silicon-rich oxide in a pre-clean chamber in a simple manner so that silicon-rich oxide in a bell-jar is efficiently and quickly removed to reduce the maintenance time and promote production efficiency.

The method for cleaning out silicon-rich oxide in a pre-clean chamber according to the invention is featured by forming plasma from fluoride to allow the plasma to react with a layer of silicon-rich oxide formed on a bell-jar to form volatile reactants, and then drawing out the reactants. Therefore, the silicon-rich oxide in the bell-jar is removed efficiently and quickly.

To achieve the objective of the invention, a method for cleaning out silicon-rich oxide in a pre-clean chamber according to the invention includes a fluoride induction step, a plasma formation step and a draw-out step. A fluoride is induced into the pre-clean chamber in the fluoride induction step. The fluoride is ionized into plasma in the pre-clean chamber to react with the silicon-rich oxide on the bell-jar in the pre-clean chamber in the plasma formation step. Then, volatile reactants formed by the reaction of the fluoride plasma with the silicon-rich oxide are drawn out of the pre-clean chamber to remove the silicon-rich oxide on the bell-jar in the pre-clean chamber in the draw-out step.

### BRIEF DESCRIPTION OF THE DRAWINGS

These and other objects and advantages of the invention will become apparent by reference to the following description and accompanying drawings wherein:

FIG. 1 is a schematic view showing the major part of a conventional PVD device;

FIG. 2 is an exploded view of a conventional pre-clean chamber with which a vacuum pump is associated; and

FIG. 3 is a schematic view showing the essential part of a PVD device employed in one embodiment of the method for cleaning out silicon-rich oxide in a pre-clean chamber according to the invention.

### DETAIL DESCRIPTION OF THE INVENTION

Hereafter, a concrete embodiment of the invention will be described in detail.

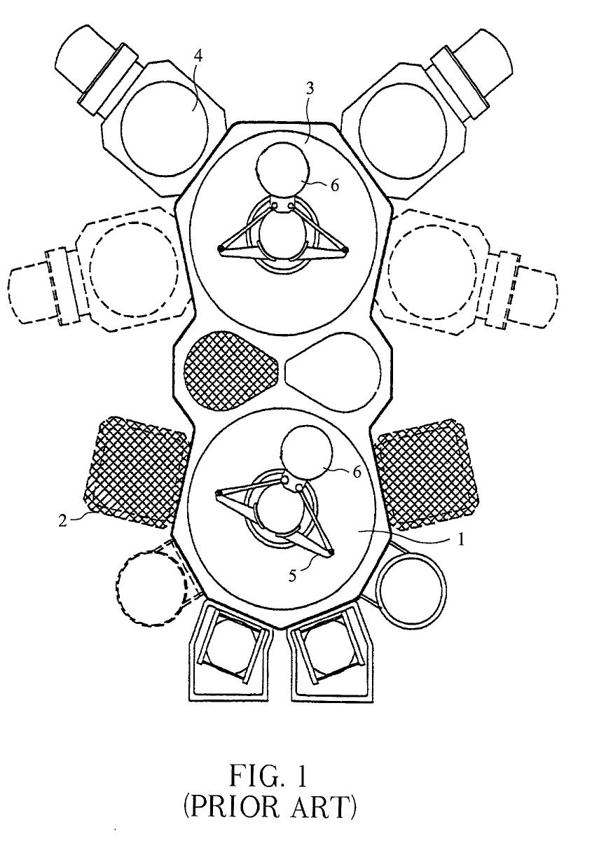

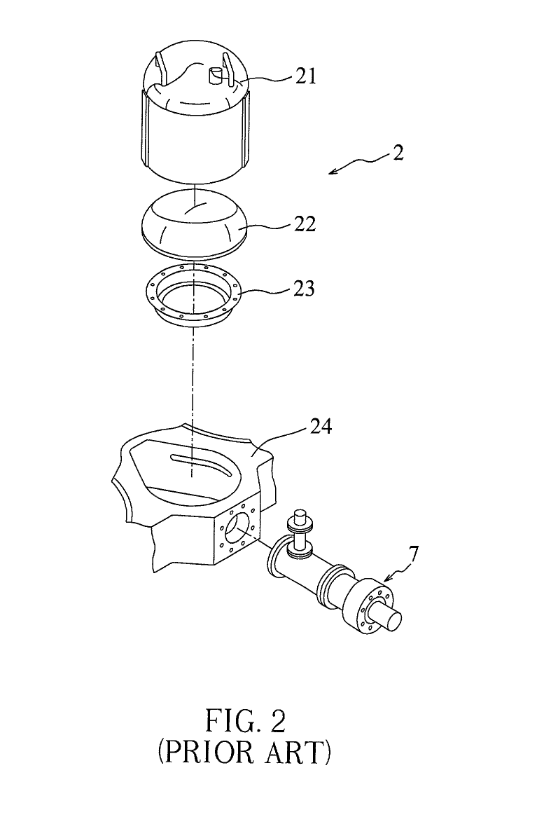

In order to conveniently describe the method and avoid redundant repetition, it should be previously pointed out that the reference numbers for illustrating the pre-clean chamber of a PVD device shown in FIG. 1 and FIG. 2 continue to be used in this embodiment.

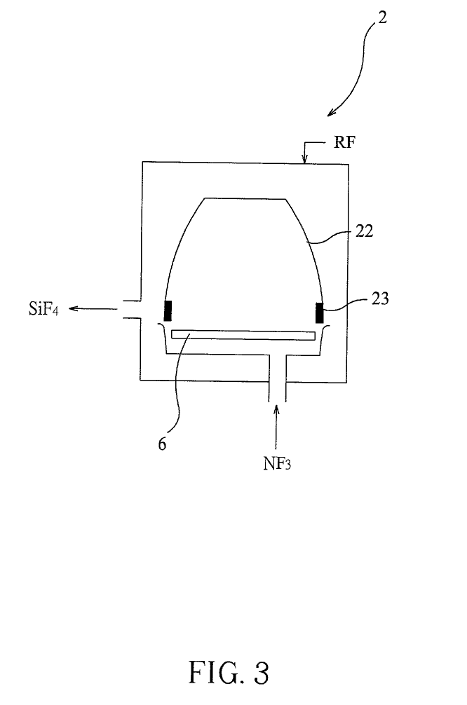

The method for cleaning out silicon-rich oxide in a pre-clean chamber according to the invention is used when a layer of silicon-rich oxide with a certain thickness is formed on a bell-jar of a pre-clean chamber of a PVD device. The method for cleaning out silicon-rich oxide in a pre-clean chamber according to the invention includes a fluoride induction step, a plasma formation step and a draw-out step. As shown in FIG. 3, in the fluoride induction step, a fluoride is induced into the pre-clean chamber 2. In this case, the fluoride is NF₃. In the plasma formation step, the fluoride is ionized into plasma in the pre-clean chamber 2. Therefore, the fluoride plasma is allowed to react with the silicon-rich oxide on the bell-jar 22 in the pre-clean chamber 2. Ionization of the fluoride into plasma is achieved by using a radio frequency generator 21 in the pre-clean chamber 2.

In the draw-out step, the volatile reactants formed by the reaction of the fluoride plasma with the silicon-rich oxide are drawn out of the pre-clean chamber 2 so as to remove the silicon-rich oxide on the bell-jar 22 in the pre-clean chamber 2.

As shown in the following equation, the reactant formed by the reaction of the fluoride plasma with the silicon-rich oxide is SiF₄ in form of gas.

Si+F→SiF_{4(g)}

The SiF₄ gas can be drawn out by using a vacuum pump 7 (FIG. 2).

Summarizing the above, with the method for cleaning out silicon-rich oxide in a pre-clean chamber according to the invention, simply inducing the fluoride into the pre-clean chamber 2 and then allowing the fluoride plasma to react with the silicon-rich oxide on the bell-jar 22 in the pre-clean chamber 2 to remove the silicon-rich oxide on the bell-jar is enough to complete the process. Therefore, the complicated procedure employed in prior art is not required at all. In other words, with the method for cleaning out silicon-rich oxide in a pre-clean chamber, the silicon-rich oxide on the bell-jar is efficiently and quickly removed in a simple manner so that it is possible to reduce the maintenance time and promote production efficiency.

While this invention has been described with reference to an illustrative embodiment, this description is not intended to be construed in a limiting sense. Various modifications and combinations of the illustrative embodiment, as well as other embodiments of the invention, will be apparent to persons skilled in the art upon reference to the description. It is therefore intended that the appended claims encompass any such modifications or embodiments.

What is claimed is:

1. A method for cleaning out silicon-rich oxide in a pre-clean chamber, the pre-clean chamber comprising a bell-jar having silicon-rich oxide formed thereon, comprising
a fluoride induction step in which a fluoride is induced into the pre-clean chamber;
a plasma formation step in which the fluoride is ionized into plasma in the pre-clean chamber to react with the silicon-rich oxide on the bell-jar in the pre-clean chamber; and
a draw-out step in which reactants formed by reaction of the plasma with the silicon-rich oxide are drawn out of the pre-clean chamber so as to clear out the silicon-rich oxide on the bell-jar in the pre-clean chamber.

2. The method for cleaning out silicon-rich oxide in a pre-clean chamber as claimed in claim 1, wherein
the pre-clean chamber is a pre-clean chamber of a physical vapor deposition device.

3. The method for cleaning out silicon-rich oxide in a pre-clean chamber as claimed in claim 1, wherein
the fluoride is formed into plasma by radio-frequency.

4. The method for cleaning out silicon-rich oxide in a pre-clean chamber as claimed in claim 1, wherein
the fluoride is NF₃.

5. The method for cleaning out silicon-rich oxide in a pre-clean chamber as claimed in claim 1, wherein
the reactants include SiF₄.
